(19) United States
(12) Patent Application Publication
(10) Pub. No.: US 2026/0321633 A1
(43) Pub. Date: Oct. 15, 2026

(54) SECONDARY BATTERY NEGATIVE ELECTRODE, SECONDARY BATTERY, AND METHOD FOR MANUFACTURING SECONDARY BATTERY NEGATIVE ELECTRODE

(71) Applicant: Panasonic Energy Co., Ltd., Moriguchi-shi, Osaka (JP)

(72) Inventors: Hiroki Nakado, Tokushima Ken (JP); Takamitsu Tashita, Tokushima Ken (JP); Akihiro Katogi, Osaka Fu (JP); Ryo Tamagawa, Tokushima Ken (JP); Sachiyo Kaneko, Tokushima Ken (JP)

(73) Assignee: Panasonic Energy Co., Ltd., Moriguchi-shi, Osaka (JP)

(21) Appl. No.: 19/105,493

(22) PCT Filed: Aug. 31, 2023
(86) PCT No.: PCT/JP2023/031854

§ 371 Date: Feb. 21, 2025

(30) Foreign Application Priority Data
Aug. 31, 2022 (JP) 2022-138633

(51) Int. Cl. H01M 4/583; H01M 4/02; H01M 4/04; H01M 4/36; H01M 4/38

(52) U.S. Cl. CPC H01M 4/583; H01M 4/0416; H01M 4/364; H01M 4/366; H01M 4/386; H01M 2004/021; H01M 2004/027

(57) ABSTRACT

A secondary battery negative electrode includes a negative electrode mixture layer having a thickness T and carried on a negative electrode current collector. A negative electrode active material in the negative electrode mixture layer contains graphite particles. The graphite particles include graphite particles A having an internal porosity of larger than 5%, and graphite particles B having an internal porosity of 5% or less. The negative electrode mixture layer includes a first layer, a second layer, and a third layer in order from the side of the negative electrode current collector. The second layer includes a 2a layer and a 2b layer provided on a first region and a second region of the first layer, respectively.

### TECHNICAL FIELD

The present disclosure relates to a secondary battery negative electrode, a secondary battery, and a method of producing a secondary battery negative electrode.

### BACKGROUND OF THE INVENTION

Nonaqueous electrolyte secondary batteries, particularly lithium ion secondary batteries, have high voltage and high energy density, and are widely used as power sources for small electronic devices such as portable devices.

Patent Literature 1 proposes an electrode active material layer, formed on a current collector, for a nonaqueous electrolyte secondary battery, wherein the porosity is changed to increase stepwise or continuously in the thickness direction from the side of the current collector toward the surface side, and the degree of inclination of the porosity in the thickness direction is 3.5 to 4.0%/10 μm.

### CITATION LIST

### Patent Literature

[Patent Literature 1] Japanese Laid-Open Patent Publication No. 2015-037008

### SUMMARY OF INVENTION

### Technical Problem

Improvement in rapid charging characteristics and cycle characteristics is required for secondary batteries.

### Solution to Problem

In view of the foregoing, one aspect of the present disclosure relates to a secondary battery negative electrode that includes a negative electrode mixture layer containing a negative electrode active material; and a negative electrode current collector carrying the negative electrode mixture layer, wherein the negative electrode active material contains graphite particles, the graphite particles include graphite particles A having an internal porosity of larger than 5%, and graphite particles B having an internal porosity of 5% or less, the negative electrode mixture layer includes a first layer, a second layer, and a third layer in order from a side of the negative electrode current collector, the second layer includes a 2a layer and a 2b layer respectively provided on a first region and a second region of the first layer, given that MB₁, MB₂ₐ, MB_{2b}, and MB₃ respectively represent proportions (% by mass) of the graphite particles B in a sum of the graphite particles A and the graphite particles B contained in the first layer, the 2a layer, the 2b layer, and the third layer, the MB₁, the MB₂ₐ, the MB_{2b}, and the MB₃ satisfy a relationship of: 0≤MB₁≤MB₂ₐ<50<MB_{2b}≤MB₃≤100, and given that T represents a thickness of the negative electrode mixture layer, a thickness of the third layer is larger than 0.05T.

Another aspect of the present disclosure relates to a secondary battery including a positive electrode, a negative electrode, and a nonaqueous electrolyte, wherein the negative electrode is the above-described secondary battery negative electrode.

A still another aspect of the present disclosure relates to a method of producing a secondary battery negative electrode including: a first step of preparing a negative electrode slurry containing graphite particles; a second step of forming a negative electrode mixture layer by applying the negative electrode slurry to a surface of a negative electrode current collector, followed by drying, and a third step of compressing a stack of the negative electrode mixture layer and the negative electrode current collector, wherein in the first step, a first negative electrode slurry, a second negative electrode slurry, and a third negative electrode slurry are prepared to prepare the negative electrode slurry, in the second step, the negative electrode mixture layer is formed by applying the first negative electrode slurry, the second negative electrode slurry, and the third negative electrode slurry in order to the surface of the negative electrode current collector, the negative electrode mixture layer being composed of a first layer, a second layer, and a third layer disposed in order from a side of the negative electrode current collector, the second negative electrode slurry includes a 2a negative electrode slurry and a 2b negative electrode slurry, a step of forming the second layer includes a step of forming 2a layers and 2b layers by applying the 2a negative electrode slurry and the 2b negative electrode slurry to a first region and a second region of a first negative electrode slurry application region of the first negative electrode slurry, respectively, the 2a layers and the 2b layers forming the second layer, the graphite particles include graphite particles A having an internal porosity of larger than 5%, and graphite particles B having an internal porosity of 5% or less, given that MB₁, MB₂ₐ, MB_{2b}, and MB₃ respectively represent proportions (% by mass) of the graphite particles B in a sum of the graphite particles A and the graphite particles B contained in the first negative electrode slurry, the 2a negative electrode slurry, the 2b negative electrode slurry, and the third negative electrode slurry, the MB₁, the MB₂ₐ, the MB_{2b}, and the MB₃ satisfy a relationship of: 0≤MB₁≤MB₂ₐ<50<MB_{2b}≤MB₃≤100, and given that T represents a thickness of the negative electrode mixture layer, a thickness of the third layer is larger than 0.05T.

### Advantageous Effects of Invention

According to the present disclosure, rapid charging characteristics and cycle characteristics of a secondary battery can be improved.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic cross-sectional view of an example of a secondary battery negative electrode according to an embodiment of the present disclosure.

FIG. 2 is a diagram illustrating an example of an arrangement pattern of 2a layers and 2b layers.

FIG. 3A is a diagram illustrating a variation of the arrangement pattern of the 2a layers and the 2b layers.

FIG. 3B is a diagram illustrating another variation of the arrangement pattern of the 2a layers and the 2b layers.

FIG. 3C is a diagram illustrating still another variation of the arrangement pattern of the 2a layers and the 2b layers.

FIG. 4 is a schematic cross-sectional view of a graphite particle serving as a negative electrode active material.

FIG. 5 is a schematic perspective view, with a part cut away, of a secondary battery according to an embodiment of the present disclosure.

### DESCRIPTION OF EMBODIMENTS

Embodiments of the present disclosure are described below by way of examples, but the present disclosure is not limited to the examples described below. In the following description, specific numerical values and materials may be exemplified in some cases, but other numerical values and other materials may be adopted as long as the effects of the present disclosure can be obtained. In the present description, the phrase “a numerical value A to a numerical value B” means to include the numerical value A and the numerical value B, and can be replaced with “a numerical value A or more and a numerical value B or less”. In the following description, when the lower and upper limits of numerical values related to specific physical properties, conditions, or the like are mentioned as examples, any of the mentioned lower limits and any of the mentioned upper limits can be combined in any combination as long as the lower limit is not equal to or more than the upper limit. When a plurality of materials are mentioned as examples, one kind of them may be selected and used along, or two or more types of them may be used in combination.

The present disclosure encompasses a combination of matters recited in any two or more claims selected from multiple claims in the appended claims. In other words, as long as no technical contradiction arises, matters recited in any two or more claims selected from multiple claims in the appended claims can be combined.

### (Secondary Battery Negative Electrode)

A secondary battery negative electrode according to an embodiment of the present disclosure includes a negative electrode mixture layer containing a negative electrode active material, and a negative electrode current collector carrying the negative electrode mixture layer. The negative electrode active material contains graphite particles. The graphite particles include graphite particles A having an internal porosity of larger than 5%, and graphite particles B having an internal porosity of 5% or less. The negative electrode mixture layer includes a first layer, a second layer, and a third layer in the order from the side of the negative electrode current collector. The second layer includes a 2a layer and a 2b layer respectively provided on a first region and a second region of the first layer. The first region and the second region do not overlap each other. Given that MB₁, MB₂ₐ, MB_{2b}, and MB₃ respectively represent the proportions (% by mass) of the graphite particles B in the graphite particles (the sum of the graphite particles A and the graphite particles B) contained in the first layer, the 2a layer, the 2b layer, and the third layer. Under the above definition, MB₁, MB₂ₐ, MB_{2b}, and MB₃ satisfy the relationship of 0≤MB₁≤MB₂ₐ<50<MB_{2b}≤MB₃≤100. Given that T represents the thickness of the negative electrode mixture layer, the thickness of the third layer is larger than 0.05T.

By using the secondary battery negative electrode meeting the above configuration, cycle characteristics and rapid charging characteristics of the secondary battery can be enhanced.

The 2a layer and the 2b layer are formed to form the second layer between the first layer and the third layer. The 2a layer (first region of the first layer) may be provided as multiple divided layers. The 2b layer (the second region of the first layer) may be provided as multiple divided layers. The 2a layers (first region of the first layer) and the 2b layers (second region of the first layer) may be arranged in an alternating pattern. Either the 2a layers or the 2b layers (the first region and the second region of the first layer) may be dispersed in island shapes within a sea matrix of the other layers. When the second layer is viewed in the normal direction of a main surface of the negative electrode current collector, the proportion of the total area of the 2b layers in the sum of the total area of the 2a layers and the total area of the 2b layers may be, for example, 10% or more and 75% or less, or may be 40% or more and 55% or less, or may be about 50%.

The first layer is a layer provided closest to the negative electrode current collector in the negative electrode mixture layer. The third layer is a layer provided closest to the surface side of the negative electrode in the negative electrode mixture layer. The second layer is a layer provided between the first layer and the third layer. The negative electrode mixture layer may further include another layer (fourth layer) other than the first layer to the third layer as long as the effects of the first layer to the third layer are not impaired. The fourth layer may be provided between the first layer and the second layer, for example. One example of the fourth layer is a layer which is formed of a single layer unlike the second layer, and in which the proportion of the graphite particles B in the graphite particles is more than 50% by mass unlike the first layer. The thickness T of the negative electrode mixture layer is the total thickness of the first layer, the second layer, and the third layer. When the negative electrode mixture layer includes the fourth layer, the thickness T means the thickness of the negative electrode mixture layer except the fourth layer.

The first layer and the 2a layers are layers that satisfy the relationship of 0≤MB₁≤MB₂ₐ<50 and that have a large proportion of the graphite particles A in the graphite particles. The third layer and the 2b layers are layers that satisfy the relationship of 50<MB_{2b}≤MB₃≤100 and that have a large proportion of the graphite particles B in the graphite particles.

The graphite particles A are easily deformed during compression of the negative electrode, and voids between the particles are small in the first layer containing a large amount of the graphite particles A. Placement of the first layer on the side of the negative electrode current collector improves adhesion between the negative electrode mixture layer and the negative electrode current collector to improve cycle characteristics.

Furthermore, a part of the second layer is constituted by the 2a layers. The 2a layers contain a large amount of the graphite particles A that are softer than the graphite particles B and that are easily deformed. Placement of the 2a layers inside the negative electrode mixture layer relaxes stresses generated in the negative electrode mixture layer due to expansion and contraction of the negative electrode active material during charging and discharging. Thus, cycle characteristics are improved.

The graphite particles B are hard and are difficult to deform during compression of the negative electrode. Voids between the particles are accordingly large in the third layer containing a large amount of the graphite particles B. As such, diffusion paths of an electrolyte tend to be formed. Placement of the third layer on the surface side of the negative electrode (the negative electrode mixture layer) allows the electrolyte to easily permeate the negative electrode mixture layer.

Furthermore, parts of the second layer is constituted by the 2b layers. The 2b layers contain a large amount of the graphitic particles B to increase the voids between the particles. Placement of the 2b layers inside the negative electrode mixture layer allows the electrolyte to easily diffuse from the surface of the negative electrode mixture layer into the inside, and significantly increases permeability of the electrolyte through the entire negative electrode (the negative electrode mixture layer), thereby improving rapid charge characteristic.

When the relationship of 0≤MB₁≤MB₂ₐ<50 is satisfied, the above-described effects by the arrangement of the first layer and the 2a layers can be efficiently obtained. When the relationship of 50<MB₂ₐ≤MB₃≤100 is satisfied, the above-described effects by the arrangement of the 2b layers and the third layer can be efficiently obtained.

However, when the thickness of the third layer is 0.05T or less, the effect by formation of the third layer may be insufficient, leading to impairment of rapid charge characteristic.

In view of improving cycle characteristics, MB₂ₐ is 0% by mass or more and less than 50% by mass, and preferably 0% by mass or more and 40% by mass or less. In view of improving rapid charge characteristic, MB_{2b} is larger than 50% by mass and 100% by mass or less, and preferably 60% by mass or more and 100% by mass or less. In view of improving cycle characteristics and rapid charging characteristics, MB₂ₐ/MB_{2b} is preferably 0 or more and 2/3 or less, and more preferably 0 or more and ¼ or less.

The first layer (or the first layer and the 2a layers) may contain only the graphite particles A as the graphite particles. The third layer (or the third layer and the 2b layers) may contain only the graphite particles B as the graphite particles.

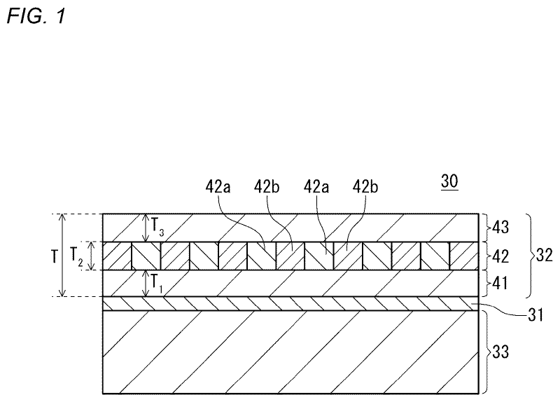

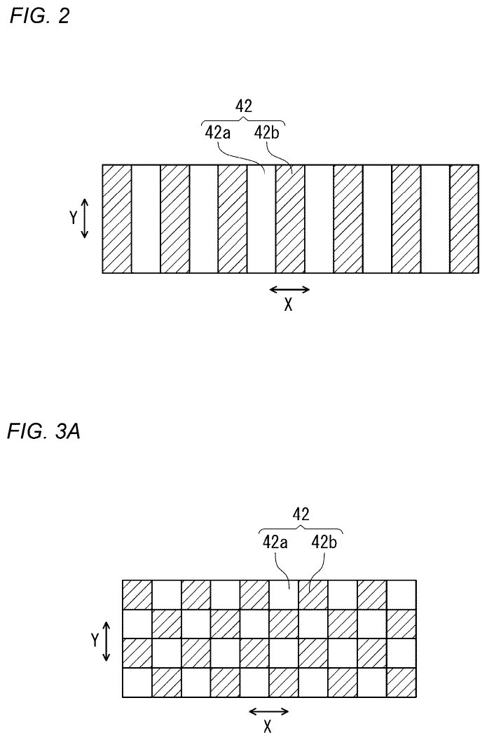

FIG. 1 is a schematic cross-sectional view of an example of a secondary battery negative electrode according to an embodiment of the present disclosure. FIG. 2 is a diagram illustrating an example of the arrangement pattern of the 2a layers and the 2b layers. FIG. 2 is a view of the second layer as viewed in the normal direction of a main surface of the negative electrode current collector. The hatched parts in FIG. 2 represent the 2b layers.

A negative electrode 30 includes a sheet-like (foil-like) negative electrode current collector 31, a negative electrode mixture layer 32 carried on one of the surfaces of the negative electrode current collector 31, and a negative electrode mixture layer 33 carried on the other of the surfaces of the negative electrode current collector 31. The negative electrode mixture layer 32 and the negative electrode mixture layer 33 have the same configuration as each other. Hereinafter, the negative electrode mixture layer 32 will be described in detail.

The negative electrode mixture layer 32 contains graphite particles that serves as a negative electrode active material. The graphite particles include graphite particles A having an internal porosity of larger than 5%, and graphite particles B having an internal porosity of 5% or less. The negative electrode mixture layer 32 includes a first layer 41, a second layer 42, and a third layer 43 in the order from the side of the negative electrode current collector 31. The second layer 42 includes 2a layers 42a provided on first regions of the first layer 41, and 2b layers 42b provided on second regions of the first layer 41.

The proportion MB₁ (% by mass) of the graphite particles B in the graphite particles contained in the first layer 41, the proportion M₂ₐ (% by mass) of the graphite particles B in the graphite particles contained in the 2a layers 42a, the proportion MB_{2b} (% by mass) of the graphite particles B in the graphite particles contained in the 2b layers 42b, and the proportion MB₃ (% by mass) of the graphite particles B in the graphite particles contained in the third layer 43 satisfy the relationship of 0≤MB₁≤MB₃<50<MB_{2b}≤MB₃≤100.

The negative electrode mixture layer 32 has a thickness T. The thickness T is the total thickness a thickness T₁ of the first layer 41, a thickness T₂ of the second layer 42, and a thickness T₃ of the third layer 43. The thickness T of the negative electrode mixture layer 32 is 50 μm or more and 300 μm or less, for example. The thickness T₃ of the third layer 43 is larger than 0.05T. The thickness ratio T₂/T₃ of the second layer 42 to the third layer 43 is ⅓ or more and 5 or less, for example. From the point of view of easy arrangement of the first layer to the third layer in a well-balanced manner, the thickness T₂ of the second layer 42 is preferably 0.1T or more (or 0.2T or more) and 0.5T or less. Similarly, the thickness T₃ of the third layer 43 is preferably 0.1T or more and 0.3T or less. Similarly, the thickness T₁ of the first layer 41 is 0.25T or more and 0.75T or less, for example.

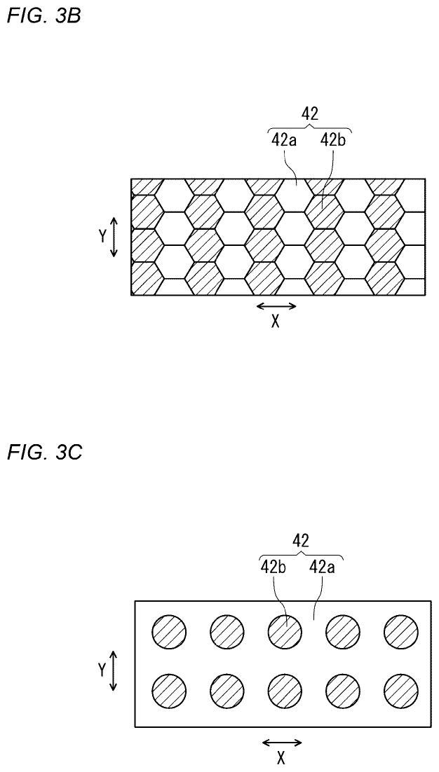

The 2a layers 42a and the 2b layers 42b are arranged in an alternating pattern. The 2a layers 42a and the 2b layers 42b are arranged in stripes in the width direction (Y direction) of the negative electrode current collector, and the 2a layers 42a and the 2b layers 42b have substantially the same width as each other. The 2a layers 42a and the 2b layers 42b have substantially the same width and are arranged at regular intervals. In the second layer, it is preferable to form a regularly repeated pattern as illustrated in FIG. 2 and FIG. 3A to FIG. 3C which will be described later. In this case, the effects of the 2a layers and the 2b layers can be obtained stably in the entire negative electrode.

The arrangement pattern of the 2a layers and the 2b layers is not limited to the arrangement pattern illustrated in FIG. 2. The 2a layers and the 2b layers may be arranged in stripes in the length direction (X direction) of the negative electrode current collector, and may have different widths from each other.

The arrangement pattern of the 2a layers and the 2b layers may be a checkerboard arrangement pattern as illustrated in FIG. 3A. In FIG. 3A, rectangular 2a layers 42a and rectangular 2b layers 42b (hatched portions in FIG. 3A) are alternately arranged in the length direction (X direction) and the width direction (Y direction) of the negative electrode current collector.

The arrangement pattern of the 2a layers and the 2b layers may be a honeycomb-like arrangement pattern illustrated in FIG. 3B. In FIG. 3B, portions in which hexagonal 2a layers 42a are arranged in a line in the width direction (Y direction) of the negative electrode current collector and portions in which hexagonal 2b layers 42b are arranged in a line in the width direction (Y direction) of the negative electrode current collector (hatched portions in FIG. 3B) are alternately arranged in a repeated pattern.

Or, the 2a layers (or the 2b layers) may be distributed in an island-like manner within a sea matrix of the 2b layers (or the 2a layers). The shape of the islands is not particularly limited, and may be a circular shape or a polygonal shape such as a rectangle. Preferably, a plurality of islands have substantially the same shape and size as each other and are regularly arranged at regular intervals. In this case, the effects of the 2a layers and the 2b layers are stably obtained in the entire negative electrode.

For example, as illustrated in FIG. 3C, circular island portions (hatched portions in FIG. 3C) of the 2b layers 42b may be arranged in a sea matrix of the 2a layers 42a in a distributed manner. The island portions of the 2b layers 42b are approximately the same sized and regularly spaced at certain intervals. The sea matrix and the island portions may be the 2b layer and the 2a layer, respectively.

### (Graphite Particles)

The negative electrode mixture layer contains graphite particles that serves as a negative electrode active material. The graphite particles include graphite particles A having an internal porosity of larger than 5%, and graphite particles B having an internal porosity of 5% or less. The internal porosity of the graphite particles A is preferably 8% or more and 20% or less, and more preferably 12% or more and 18% or less. The internal porosity of the graphite particles Bis preferably 1% or more (or 2% or more) and 5% or less. When the internal porosities of the graphite particles A and the graphite particles B are within the above ranges, cycle characteristics and rapid charging characteristics are easily improved, which is advantageous for increasing the capacity, the internal porosities of the graphite particles A and the graphite particles B can be controlled within the above ranges by using the production method described later.

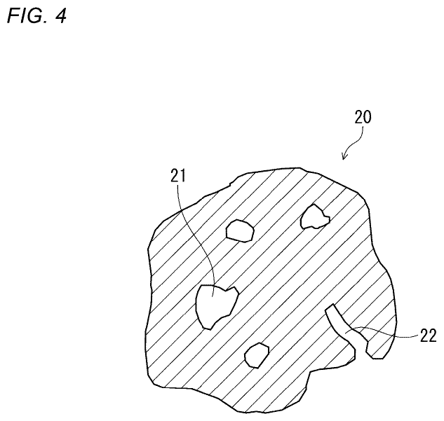

Here, FIG. 4 is a diagram schematically illustrating a cross section of a graphite particle.

A graphite particle 20 has internal voids 21 closed inside the graphite particle 20 and an external void 22 communicating with the space outside the graphite particle 20. The external void 22 is included in voids between the negative electrode active material particles in the negative electrode mixture layer. The graphite particles A have more internal voids 21 and more external voids 22 than the graphite particles B.

Here, the internal porosity of the graphite particle 20 means the ratio of an area S2 of an internal void 21 to an area S1 of the graphite particle 20 in cross section of the graphite particle 20, and is determined using (S2/S1)×100. The area S1 of the graphite particle 20 is the area of a region surrounded by the outer periphery of the graphite particle 20, and means the entire area of the hatched portion and the internal voids 21 in FIG. 2. When there are a plurality of internal voids 21, the area S2 of an internal void 21 means the total area of the plurality of internal voids 21.

The internal porosity of the graphite particles can be determined using the following method.

A battery at the initial stage (an unused battery or a battery having been charged and discharged several times) is disassembled to take out a negative electrode. A part of the negative electrode is sampled, and a sample cross section of its negative electrode mixture layer is obtained, for example, using an ion milling apparatus. As the ion milling apparatus, a device “IM4000 PLUS” manufactured by Hitachi High-Tech Corporation can be used, for example. Alternatively, graphite particles to be contained in a negative electrode slurry used in production of a secondary battery negative electrode may be obtained as a sample. The sample of the graphite particles may be embedded, for example, in an epoxy resin and polished to obtain a cross section of a plurality of graphite particles, which can then be used as the sample cross section. A cross sectional image of the sample is obtained by capturing a reflected electron image (magnification: 3000× to 5000×) of the sample cross-section using a scanning electron microscope (SEM). The cross-sectional image of the sample obtained as above is taken into a computer, and binarization is performed. For example, the image analysis software “ImageJ” produced by the National Institutes of Health can be used for binarization of the cross-sectional image. In binarization, in the cross-sectional image, the negative electrode active material particles (including voids inside the particles) are depicted in black, and the voids between the particles are depicted in white.

A graphite particle having a maximum diameter of 5 μm or more and 50 μm or less is arbitrarily selected from the binarized cross-sectional image. The area S1 of the graphite particle and the area S2 of the internal voids of the graphite particle are calculated. Noted that a minute void having a maximum diameter of 3 μm or less may be difficult to distinguish between an internal void and an external void in image analysis. Therefore, a void having a maximum diameter of 3 μm or less is regarded as an internal void. When the negative electrode active material contains graphite particles and an Si-based material, the graphite particles and the particles of the Si-based material can be distinguished using the SEM image (reflected-electron images) of the sample cross-section obtained as above. In the SEM image of the sample cross section, the graphitic particles are depicted in black, and the particles of the Si-based material (such as SiOx particles) are depicted in gray.

Using the area S1 of the graphite particle and the area S2 of the internal voids obtained as above, the internal porosity (%) of the graphite particle is calculated using the following expression.

Internal porosity of graphitic particle=(S2/S1)×100

A graphite particle having an internal porosity of larger than 5% is determined as a graphite particle A, and a graphite particle having an internal porosity of 5% or less is determined as a graphite particle B. The average of the internal porosities of ten graphite particles A is obtained. The average of the internal porosities of the ten graphite particles B is obtained.

The graphite particles A can be produced by the following method, for example.

Coke (a precursor), which is a main raw material, is pulverized, and a binder is added to the resulting pulverized product to aggregate the pulverized product. The obtained aggregate is pressure-formed to obtain a block-shaped formed body, and the resulting formed body is fired for graphitization. The firing temperature is, for example, 2600° C. or higher, and may be 2600° C. or higher and 3000° C. or lower. The density of the formed body is 1.6 g/cm³ or more and 1.9 g/cm³ of less, for example. The obtained block-shaped graphitized product is pulverized and sifted to obtain graphite particles A having a desired size.

The mean particle diameter (D50) of the pulverized product of the coke is 12 μm or more and 20 μm or less, for example. In the present specification, the mean particle diameter (D50) means a particle diameter (volume average particle diameter) at which the cumulative volume is 50% in a particle size distribution measured using the laser diffraction-scattering method. As the measuring device, “LA-750” manufactured by Horiba, Ltd. can be used, for example.

The internal porosity of the graphite particles A may be controlled by the particle diameter of the pulverized product or the aggregate of the coke, for example. When a volatile component is added to the block-shaped formed body at the time of firing, the internal porosity of the graphite particles A may be controlled by the amount of the volatile component added to the block-shaped formed body. When a portion of the binder added to the pulverized product of the coke will volatilize during firing, the binder may also serve as a volatile component added to the formed body. In this case, the internal porosity may be controlled by the amount of the binder added. Pitch is exemplified as the binder such as above. For example, the graphite particles A, which have larger internal porosity than graphite particles B, can be produced by adding a larger amount of pitch to the pulverized product during the production process of the graphite particles A compared to the amount of pitch added during the production process of the graphite particles B.

The graphite particles B can be produced by the following method, for example.

Coke (a precursor), which is a main raw material, is pulverized, and a binder is added to the resulting pulverized product to aggregate the pulverized product. The mean particle diameter (D50) of the pulverized product of the coke is 12 μm or more and 20 μm or less, for example. The obtained aggregate is fired for graphitization, and sifted to obtain graphite particles B having a desired size. The firing temperature is, for example, 2600° C. or higher, and may be 2600° C. or higher and 3000° C. or lower.

The internal porosity of the graphite particles B can be controlled by the particle diameter of the pulverized product or the aggregate of the coke, for example. For example, in order to reduce the internal porosity, the particle diameter of the pulverized product or the aggregate of the coke should be increased. When a portion of the binder contained in the aggregate will volatilize during firing, the internal porosity may be controlled by the amount of the binder added. Pitch is exemplified as the binder such as above.

### (Method of Producing Secondary Battery Negative Electrode)

A method of producing a secondary battery negative electrode according to an embodiment of the present disclosure includes a first step to a third step. In the first step, a negative electrode slurry containing graphite particles is prepared. In the second step, the negative electrode slurry is applied to the surface of a negative electrode current collector, followed by drying to form a negative electrode mixture layer. The negative electrode mixture layer may be formed on one of the surfaces of the negative electrode current collector, or may be formed on both surfaces of the negative electrode current collector. In the third step, the stack of the negative electrode mixture layer and the negative electrode current collector is compressed.

In the first step, for example, the negative electrode slurry is prepared by dispersing a negative electrode mixture in a dispersion medium. The negative electrode mixture contains graphite particles, which serves as a negative electrode active material, as an essential component, and may contain, for example, a binder, a conductive agent, and a thickener as optional components. As the binder and the like, those exemplified later can be used. In the second step, the negative electrode slurry may be applied to one of the surfaces of a sheet-like negative electrode current collector, or the negative electrode slurry may be formed on both surfaces of the negative electrode current collector. In the third step, the long stack is rolled, for example.

In the first step, a first slurry, a second slurry, and a third slurry are prepared to prepare the negative electrode slurry. In the second step, the first slurry, the second slurry, and the third slurry are applied to the surface of the negative electrode current collector in this order to form a negative electrode mixture layer composed of a first layer, a second layer, and a third layer arranged in this order from the side of the negative electrode current collector. Drying in the second step may be performed each time the first, second, and third slurries are applied, or may be performed after the first slurry to the third slurry are applied in order.

The second slurry includes a 2a slurry and a 2b slurry. The step of forming the second layer includes a step of applying the 2a slurry and the 2b slurry to first regions and second regions of an application region of the first slurry, respectively, to form the 2a layers and the 2b layers which serve as the second layer.

The graphite particles include graphite particles A having an internal porosity of larger than 5%, and graphite particles B having an internal porosity of 5% or less. Given that MB₁, MB₂ₐ, MB_{2b}, and MB₃ respectively represent the proportions (% by mass) of the graphite particles B in the graphite particles (the sum of the graphite particles A and the graphite particles B) contained in the first slurry, the 2a slurry, the 2b slurry, and the third slurry. Under the above definition, MB₁, MB₂ₐ, MB_{2b}, and MB₃ satisfy the relationship of 0≤MB₁≤MB₂ₐ<50<MB_{2b}≤MB₃≤100. Given that T represents the thickness of the negative electrode mixture layer, the thickness of the third layer is larger than 0.05T.

The proportion of the graphite particles B in the graphite particles should be adjusted by preparing the graphite particles A and the graphite particles B separately, and allowing each slurry to contain the graphite particles A and the graphite particles B at a predetermined mass ratio. The thickness of each layer should be adjusted by the coating amount of corresponding one of the slurries.

Examples of the coating method in the second step include die coating, ink jet printing, and reverse coating (transfer method). It is possible that one of the 2a slurry and the 2b slurry is applied, and then the other of the 2a slurry and the 2b slurry is applied. The application of the 2a slurry and the 2b slurry may be performed simultaneously. The 2a slurry and the 2b slurry may be applied in a pattern such that the 2a layers and the 2b layers formed in the second step exhibit any of the exemplified arrangement patterns (any of the arrangement patterns illustrated in FIGS. 2 and 3A to 3C) in the secondary battery negative electrode.

### (Secondary Battery)

A secondary battery according to an embodiment of the present disclosure includes a positive electrode, a negative electrode, and a nonaqueous electrolyte. The negative electrode is the above-described secondary battery negative electrode. Hereinafter, the secondary battery will be described in detail.

### [Negative Electrode]

The negative electrode includes a negative electrode current collector and a negative electrode mixture layer carried on a surface of the negative electrode current collector. The negative electrode mixture layer contains a negative electrode active material as an essential component, and may contain, for example, a binder, a conductive agent, and a thickener as optional components.

The negative electrode active material contains at least graphite particles. As the graphite particles, particles of, for example, natural graphite or artificial graphite can be used. From the point of view of easy control of the internal porosity, particles of artificial graphite are preferable. The particles of natural graphite can be used as the graphite particles A. The graphite particles may contain, in part, amorphous carbon, graphitizable carbon (soft carbon), or non-graphitizable carbon (hard carbon). The mean particle diameter (D50) of the graphite particles is 1 μm or more and 30 μm or less, for example.

Graphite is a carbon material in which a graphite-type crystal structure has been developed. An interplanar spacing d002 of the (002) plane of the graphite particles measured by X-ray diffractometry may be, for example, 0.340 nm or less, or may be 0.3354 nm or more and 0.340 nm or less. A crystallite size Lc(002) of the graphite particles measured by X-ray diffractometry may be, for example, 5 nm or more, may be 5 nm or more and 300 nm or less, or may be 5 nm or more (or 10 nm or more) and 200 nm or less. The crystallite size Lc(002) is measured by the Scherrer method, for example. When the interplanar spacing d002 and the crystallite size Lc(002) of the (002) plane of the graphite particles are within the above ranges, a high capacity is easily obtained.

In view of increasing the capacity, the negative electrode active material may contain an Si-based material. The mean particle diameter (D50) of the particles of the Si-based material is 1 μm or more and 25 μm or less, for example. Examples of the Si-based material include silicon alone, silicon-containing alloys, and silicon-containing composites. The silicon-containing alloys contain silicon (Si) and at least one element selected from the group consisting of tin (Sn), nickel (Ni), iron (Fe), copper (Cu), titanium (Ti), manganese (Mn), and aluminum (Al), for example.

The silicon-containing composites may include an ion conducting phase (matrix phase) and silicon phases (particulate Si phases) dispersed in the phase. Examples of the ion conducting phase include a silicon oxide phase, a silicate phase (e.g., a lithium silicate phase), and a carbon phase.

The silicon oxide phase is an SiO₂ phase containing 95% by mass or more of silicon dioxide, for example. Particles of a composite material in which the silicon phases are dispersed in an SiO₂ phase are represented by SiOₓ, where 0.8≤x≤1.6, for example. The lithium silicate phase may have a composition represented by formula: Li_{2z}SiO_{2+z} (0<z<2), for example. z may be 1/2, or may be 1. Particles of a composite material in which the silicon phases are dispersed in the silicate phase can be obtained, for example, by pulverizing a mixture of silicate and raw material silicon under stirring using a ball mill or the like for micronization, followed by heat-treatment of the resulting mixture in an inert atmosphere. The carbon phase contains amorphous carbon having low crystallinity, for example.

In view of improving conductivity, at least parts of the surfaces of the particles of the composite material may be coated with conductive layers. The conductive layers contain a conductive material such as conductive carbon. The coating amount of the conductive layers is, for example, 1 part by mass or more and 10 parts by mass or less per total 100 parts by mass of the particles of the composite material and the conductive layers. The particles of the composite material with the conductive layers on the surfaces thereof are obtained, for example, by mixing coal pitch or the like with the particles of the composite material, followed by heat treatment on the resulting mixture in an inert atmosphere.

An Si-based material has a larger capacity density than graphitic particles. The graphite particles have a lower degree of expansion and contraction during charging and discharging than the Si-based material. When the graphite particles and the Si-based material are used in combination, the proportion of the Si-based material in the negative electrode active material (the sum of the graphite particles and the Si-based material) is preferably 1% by mass or more and 10% by mass or less, and more preferably 3% by mass or more and 7% by mass or less. In this case, it is easy to simultaneously achieve improvements in cycle characteristics and increase in capacity.

Examples of the binder include resin materials such as: fluororesins such as polytetrafluoroethylene and polyvinylidene fluoride (PVDF); polyolefin resins such as polyethylene and polypropylene; polyamide resins such as aramid resin; polyimide resins such as polyimide and polyamideimide; acrylic resins such as polyacrylic acid, methyl polyacrylate, and ethylene-acrylic acid copolymers; vinyl resins such as polyacrylonitrile and polyvinyl acetate; polyvinyl pyrrolidone; polyether sulfone; and rubber-like materials such as styrene-butadiene copolymer rubber (SBR). One binder may be used alone, or two or more binders may be used in combination.

Examples of the conductive agent include: carbons such as acetylene black; conductive fibers such as carbon fibers and metal fibers; and metal powders such as aluminum. One conductive agent may be used alone, or two or more conductive agents may be used in combination.

Examples of the thickener include: carboxymethylcellulose (CMC) and modified products thereof (including salts such as Na salts); cellulose derivatives (e.g., cellulose ether) such as methylcellulose; and saponified products of polymers having a vinyl acetate unit, such as polyvinyl alcohol. One thickener may be used alone, or two or more thickeners may be used in combination.

The dispersion medium is not particularly limited, and examples thereof include water, alcohols such as ethanol, ethers such as tetrahydrofuran, amides such as dimethylformamide, N-methyl-2-pyrrolidone (NMP), and mixed solvents of these.

As the negative electrode current collector, a non-perforated conductive substrate (e.g., a metal foil) or a perforated conductive substrate (e.g., a mesh body, a net body, or a punched sheet) is used. Examples of the material of the negative electrode current collector include stainless steel, nickel, nickel alloys, copper, and copper alloys. The thickness of the negative electrode current collector is not particularly limited, and is preferably 1 to 50 μm, and more preferably 5 to 20 μm.

### [Positive Electrode]

The positive electrode includes a positive electrode current collector and a positive electrode mixture layer carried on a surface of the positive electrode current collector, for example. The positive electrode mixture layer can be formed by applying a positive electrode slurry in which a positive electrode mixture is dispersed in a dispersion medium to a surface of the positive electrode current collector, followed by drying. The dried coating may be rolled if necessary. The positive electrode mixture layer may be formed on one of the surfaces of the sheet-shaped positive electrode current collector, or may be formed on both surfaces thereof. The positive electrode mixture contains a positive electrode active material as an essential component, and may contain, for example, a binder and a conductive agent as optional components. NMP or the like is used as the dispersion medium of the positive electrode slurry.

As the positive electrode active material, a composite oxide containing lithium and a transition metal such as Ni, Co, or Mn can be used, for example. Examples thereof include LiₐCoO₂, LiₐNiO₂, LiₐMnO₂, LiₐCo_{b}Ni_{1-b}O₂, LiₐCo_{b}Me_{1-b}O_{c}, LiₐNi_{1-b}Me_{b}O_{c}, LiₐMn₂O₄, LiₐMn_{2-b}MeO₄, LiMePO₄, and Li₂MePO₄F (where Me represents at least one selected from the group consisting of Na, Mg, Sc, Y, Mn, Fe, Co, Ni, Cu, Zn, Al, Cr, Pb, Sb, and B). Here, 0<a≤1.2, 0<b≤0.9, and 2.0≤c≤2.3 are satisfied. Note that the value a indicating the molar ratio of lithium increases or decreases by charging and discharging.

Among these, a lithium-nickel composite oxide represented by LiₐNi_{b}M_{1-b}O₂ (where M is at least one selected from the group consisting of Mn, Co and Al, 0<a≤1.2, and 0.3≤b≤1) is preferable. In view of increasing the capacity, it is more preferable to satisfy the relationship of 0.85≤b≤1. In view of stabilizing the crystalline structure, LiₐNi_{b}Co_{c}Al_{d}O₂ where M includes Co and Al (0<a≤1.2, 0.85≤b<1, 0<c<0.15, 0<d≤0.1, and b+c+d=1) is more preferable.

As the binder and the conductive agent, the same ones as those exemplified for the negative electrode can be used. As the conductive agent, graphite such as natural graphite or artificial graphite may be used.

The shape and thickness of the positive electrode current collector can be selected from ranges corresponding to those of the negative electrode current collector. Examples of the material of the positive electrode current collector include stainless steel, aluminum, aluminum alloys, and titanium.

### [Nonaqueous Electrolyte]

The nonaqueous electrolyte contains a nonaqueous solvent and a lithium salt dissolved in the nonaqueous solvent. The concentration of the lithium salt in the nonaqueous electrolyte is 0.5 mol/L or more and 2 mol/L or less, for example.

As the nonaqueous solvent, a cyclic carbonic acid ester, a chain carbonic acid ester, a cyclic carboxylic acid ester, or a chain carboxylic acid ester is used, for example. Examples of the cyclic carbonic acid ester include propylene carbonate and ethylene carbonate. The nonaqueous electrolyte may contain a small amount of a cyclic carbonic acid ester having an unsaturated bond, such as vinylene carbonate, or a cyclic carbonic acid ester having a fluorine atom, such as fluoroethylene carbonate, for example. Examples of the chain carbonic acid ester include diethyl carbonate, ethyl methyl carbonate, and dimethyl carbonate. Examples of the cyclic carboxylic acid ester include γ-butyrolactone and γ-valerolactone. Examples of the chain carboxylic acid ester include methyl formate, ethyl formate, propyl formate, methyl acetate, ethyl acetate, propyl acetate, methyl propionate, ethyl propionate, and propyl propionate. One nonaqueous solvent may be used alone, or two or more nonaqueous solvents may be used in combination.

Examples of the lithium salt include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylates, LiCl, LiBr, LiI, borates, and imide salts. Examples of the borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-oleate-1-benzenesulfonate-O,O′)borate. Examples of the imide salts include lithium bis(fluorosulfonyl)imide (LiN(FSO₂)₂), lithium bis(trifluoromethanesulfonyl)imide (LiN(CF₃SO₂)₂), lithium trifluoromethanesulfonate nonafluorobutanesulfonate imide (LiN(CF₃SO₂)(C₄F₉SO₂)₂), and lithium bis(pentafluoroethanesulfonyl)imide (LiN(C₂F₅SO₂)₂). One lithium salt may be used alone, or two or more lithium salts may be used in combination.

### [Separator]

In general, it is desirable to provide a separator between the positive electrode and the negative electrode. The separator has high ion permeability and moderate mechanical strength and insulating properties. As the separator, a microporous thin film, a woven fabric, or a nonwoven fabric can be used, for example. The material of the separator is preferably a polyolefin such as polypropylene or polyethylene.

The secondary battery may include, for example, a wound electrode group configured by winding the positive electrode and the negative electrode with the separator therebetween, or may include a stacked electrode group configured by stacking the positive electrode and the negative electrode with the separator therebetween. The secondary battery may be in any form, such as cylindrical, prismatic, coin, button, or laminated.

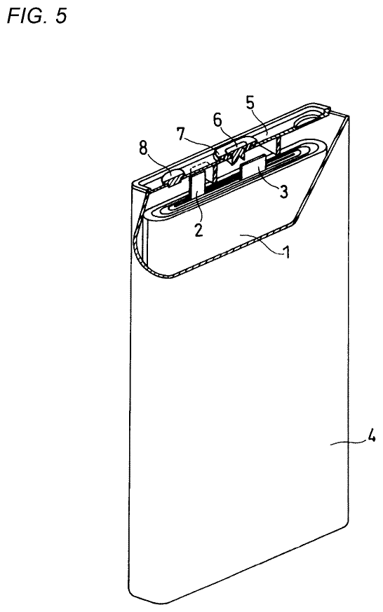

The following describes the configuration of a prismatic secondary battery as an example of the secondary battery according to the present disclosure with reference to FIG. 5. FIG. 5 is a schematic perspective view, with a part cut away, of a secondary battery according to an embodiment of the present disclosure.

The battery includes a bottomed prismatic battery case 4, and an electrode group 1 and a nonaqueous electrolyte (not illustrated) housed in the battery case 4. The electrode group 1 includes a long strip-shaped negative electrode, a long strip-shaped positive electrode, and a separator provided therebetween and preventing direct contact therebetween. The electrode group 1 is formed by winding the negative electrode, the positive electrode, and the separator around a flat plate-shaped winding core and pulling out the winding core.

One end of a negative electrode lead 3 is attached to a negative electrode current collector, for example, by welding. The other end of the negative electrode lead 3 is electrically connected to a negative electrode terminal 6 provided at a sealing plate 5 via an insulating plate (not illustrated) made of resin. The negative electrode terminal 6 is insulated from the sealing plate 5 by a gasket 7 made of resin. One end of a positive electrode lead 2 is attached to a positive electrode current collector, for example, by welding. The other end of the positive electrode lead 2 is connected to the back surface of the sealing plate 5 via an insulating plate. That is, the positive electrode lead 2 is electrically connected to the battery case 4 that also serves as a positive electrode terminal. The insulating plate separates the electrode group 1 from the sealing plate 5 and separates the negative electrode lead 3 from the battery case 4. The peripheral edge of the sealing plate 5 is fitted to the open end of the battery case 4, and the fitting part is laser-welded. In this way, the opening of the battery case 4 is sealed with the sealing plate 5. An injection port for the nonaqueous electrolyte provided in the sealing plate 5 is closed with a sealing plug 8.

### <<Supplemental Remarks>>

According to the above description of the embodiment, the following techniques are disclosed.

### (Technique 1)

A secondary battery negative electrode including:
a negative electrode mixture layer containing a negative electrode active material; and a negative electrode current collector carrying the negative electrode mixture layer, wherein
the negative electrode active material contains graphite particles,
the graphite particles include graphite particles A having an internal porosity of larger than 5%, and graphite particles B having an internal porosity of 5% or less,
the negative electrode mixture layer includes a first layer, a second layer, and a third layer in order from a side of the negative electrode current collector,
the second layer includes a 2a layer and a 2b layer respectively provided on a first region and a second region of the first layer,
given that MB₁, MB₂ₐ, MB_{2b}, and MB₃ respectively represent proportions (% by mass) of the graphite particles B in a sum of the graphite particles A and the graphite particles B contained in the first layer, the 2a layer, the 2b layer, and the third layer, the MB₁, the MB₂ₐ, the MB_{2b}, and the MB₃ satisfy a relationship of:
0≤MB₁≤MB₂ₐ<50<MB_{2b}≤MB₃≤100, and
given that T represents a thickness of the negative electrode mixture layer, a thickness of the third layer is larger than 0.05T.

### (Technique 2)

The secondary battery negative electrode according to Technique 1, wherein the internal porosity of the graphite particles A is 8% or more and 20% or less.

### (Technique 3)

The secondary battery negative electrode according to Technique 1 or 2, wherein
a thickness of the second layer is 0.1T or more and 0.5T or less, and
the thickness of the third layer is 0.1T or more and 0.3T or less.

### (Technique 4)

The secondary battery negative electrode according to any one of Techniques 1 to 3, wherein
the MB₂ₐ is 0% by mass or more and 40% by mas or less, and
the MB_{2b} is 60% by mass or more and 100% by mass or less.

### (Technique 5)

The secondary battery negative electrode according to any one of Techniques 1 to 4, wherein the negative electrode active material contains an Si-based material.

### (Technique 6)

The secondary battery negative electrode according to any one of Techniques 1 to 5, wherein a plurality of the 2a layers and a plurality of the 2b layers are arranged in an alternating pattern on the first layer.

### (Technique 7)

The secondary battery negative electrode according to Technique 6, wherein the 2a layers and the 2b layers are arranged in a striped pattern, a checkerboard pattern, or a honeycomb pattern on the first layer.

### (Technique 8)

The secondary battery negative electrode according to any one of Techniques 1 to 7, wherein either a plurality of the 2a layers or a plurality of the 2b layers are provided on the first layer, dispersed in island shapes within a sea matrix of other layers.

### (Technique 9)

A secondary battery including: a positive electrode; a negative electrode; and a nonaqueous electrolyte, wherein
the negative electrode is the secondary battery negative electrode according to Techniques 1 to 8.

### (Technique 10)

A method of producing a secondary battery negative electrode including:
a first step of preparing a negative electrode slurry containing graphite particles;
a second step of forming a negative electrode mixture layer by applying the negative electrode slurry to a surface of a negative electrode current collector, followed by drying, and
a third step of compressing a stack of the negative electrode mixture layer and the negative electrode current collector, wherein
in the first step, a first slurry, a second slurry, and a third slurry are prepared to prepare the negative electrode slurry,
in the second step, the negative electrode mixture layer is formed by applying the first slurry, the second slurry, and the third slurry in order to the surface of the negative electrode current collector, the negative electrode mixture layer being composed of a first layer, a second layer, and a third layer disposed in order from a side of the negative electrode current collector,
the second slurry includes a 2a slurry and a 2b slurry,
a step of forming the second layer includes a step of forming 2a layers and 2b layers by applying the 2a slurry and the 2b slurry to a first region and a second region of a first slurry application region of the first slurry, respectively, the 2a layers and the 2b layers forming the second layer,
the graphite particles include graphite particles A having an internal porosity of larger than 5%, and graphite particles B having an internal porosity of 5% or less,
given that MB₁, MB₂ₐ, MB_{2b}, and MB₃ respectively represent proportions (% by mass) of the graphite particles B in a sum of the graphite particles A and the graphite particles B contained in the first slurry, the 2a slurry, the 2b shiny, and the third slurry, the MB₁, the MB₂ₐ, the MB_{2b}, and the MB₃ satisfy a relationship of.
0≤MB₁≤MB₂ₐ<50<MB_{2b}≤MB₃≤100, and
given that T represents a thickness of the negative electrode mixture layer, a thickness of the third layer is larger than 0.05T.

### (Technique 11)

The method of producing a secondary battery negative electrode according to Technique 10, wherein the internal porosity of the graphite particles A is 8% or more and 20% or less.

### (Technique 12)

The method of producing a secondary battery negative electrode according to Technique 11, wherein
a thickness of the second layer is 0.1T or more and 0.5T or less, and
the thickness of the third layer is 0.1T or more and 0.3T or less.

### (Technique 13)

The method of producing a secondary battery negative electrode according to any one of Techniques 10 to 12, wherein
the MB₂ₐ is 0% by mass or more and 40% by mass or less, and
the MB_{2b} is 60% by mass or more and 100% by mass or less.

Hereinafter, the present disclosure will be described in detail based on examples and comparative examples. However, the present disclosure is not limited to the following examples.

### Examples 1 to 6 and Comparative Examples 3, 4, 6, and 7

### (Preparation of Graphite Particles A)

Coke (a precursor) to be a main raw material was pulverized to obtain a pulverized product having a mean particle diameter (D50) of 15 μm. The pulverized product was aggregated by adding pitch as a binder to the pulverized product, and the resulting aggregate was press-formed to obtain a block-shaped formed body having a density of 1.6 g/cm³ to 1.9 g/cm³. The obtained block-shaped formed body was fired at a temperature of 2800° C. for graphitization. The obtained block-shaped graphitized product was pulverized and sifted to obtain graphite particles A having a mean particle diameter (D50) of 23 μm.

### (Preparation of Graphite Particles B)

Coke (precursor) to be a main raw material was pulverized to obtain a pulverized product having a mean particle diameter (D50) of 12 μm. The pulverized product was aggregated by adding pitch as a binder to the pulverized product to obtain an aggregate having a mean particle diameter (D50) of 18 μm. The aggregate was fired at a temperature of 2800° C. for graphitization. The obtained graphitized product was sifted to obtain graphite particles B having a mean particle diameter (D50) of 23 μm.

The internal porosity of the graphite particles A determined by the method described above was in the range of 8% to 20%, and the internal porosity average was 15%. The internal porosity of the graphite particles B determined by the method described above was in the range of 1% to 5%, and the internal porosity average was 3%.

The internal porosities of the graphite particles A and the graphite particles B were adjusted by the respective amounts of the pitch added in the preparation processes of the graphite particles A and the graphite particles B. Note that as the amount of the pitch is increased, the internal porosity increases.

### (Negative Electrode Slurry Preparation)

An appropriate amount of water was added to a negative electrode mixture to obtain a negative electrode slurry. As the negative electrode mixture, a mixture of a negative electrode active material, a styrene-butadiene copolymer rubber (SBR) being a binder, and carboxymethyl cellulose (CMC) being a thickener was used. As the negative electrode active material, a mixture of graphitic particles and an Si-based material was used. In the negative electrode active material, the mass ratio between the graphite particles and the Si-based material was set to 95:5. The mass ratio of the negative electrode active material, SBR, and CMC was set to 100:1:1. As the Si-based material, SiOₓ particles (0.8≤x≤1.6, mean particle diameter (D50) 5 μm) having surfaces coated with conductive layers containing conductive carbon were used as a composite material. The amount of the conductive layers coated was set to 5 parts by mass per 100 parts by mass of the sum of SiOₓ particles and the conductive layers.

The prepared negative electrode slurry included a first slurry, a second slurry, and a third slurry. The prepared second slurry included a 2a slurry and a 2b slurry. The mixing ratio between the graphite particles A and the graphite particles B was appropriately adjusted such that the proportion (% by mass) of the graphite particles B in the graphite particles (the sum of the graphite particles A and the graphite particles B) contained in each slurry was set to a corresponding one of the values indicated in Table 1.

### (Negative Electrode Production)

A copper foil (thickness: 10 μm) was prepared as a negative electrode current collector. On both surfaces of the negative electrode current collector, any of the first slurries, any of the second slurries, and any of the third slurries were applied in this order and dried to form a first layer, a second layer, and a third layer in this order from the side of the negative electrode current collector. In the manner described above, the negative electrode mixture layer composed of the first layer to the third layer was formed. The second slurry included a 2a slurry and a 2b slurry. In the step of forming the second layer, the 2a slurry and the 2b slurry were applied to first regions and second regions of a first slurry application region of the first slurry, respectively, to form 2a layers and 2b layers that form the second layer. Each slurry was applied by die coating. The 2a layers and the 2b layers were arranged to form a striped pattern illustrated in FIG. 2. The widths of the 2a layers and the 2b layers (the width dimensions in the X-direction in FIG. 2) were substantially the same as each other. The application amounts of the respective slurries were appropriately adjusted to set the thicknesses (T1 to T3) of the first layer to the third layer to those indicated in Table 1. The thickness T of the negative electrode mixture layer per one side was set to 80 μm.

A stack of the negative electrode current collector and negative electrode mixture layers formed on the respective surfaces of the negative electrode current collector was rolled. Thus, negative electrodes were obtained.

### (Positive Electrode Production)

An appropriate amount of N-methyl-2-pyrrolidone (NMP) was added to a positive electrode mixture to obtain a positive electrode slurry.

As the positive electrode mixture, a mixture of a lithium-containing composite oxide being a positive electrode active material, graphite being a conductive agent, and polyvinylidene fluoride (PVDF) being a binder was used. LiNi_{0.88}Co_{0.09}Al_{0.03}O₂ was used as the lithium-containing composite oxide. In the positive electrode mixture, the mass ratio of the lithium-containing composite oxide, the graphite, and PVDF was set to 100:1:0.9.

The positive electrode slurry was applied to both surfaces of an aluminum foil (thickness: 15 μm) being a positive electrode current collector, and the resulting coating films were dried and rolled to form positive electrode mixture layers. Thus, a positive electrode was obtained. The doctor blade method was used to apply the positive electrode slurry.

### (Nonaqueous Electrolyte Preparation)

A nonaqueous electrolyte was prepared by adding vinylene carbonate (VC) to a nonaqueous solvent in which ethylene carbonate (EC) and dimethyl carbonate (DMC) were mixed in a volume ratio of 1:3, and dissolving LiPF₆ in the resulting mixture. The percentage content of VC in the nonaqueous electrolyte was set to 5% by mass to the entirety of the nonaqueous electrolyte. The concentration of LiPF₆ in the nonaqueous electrolyte was set to 1.5 mol/L.

### (Secondary Battery Production)

With respect to each of the negative electrodes, a positive electrode lead made of aluminum was attached to an exposed part of the positive electrode current collector of the positive electrode, and a negative electrode lead made of nickel was attached to an exposed part of the negative electrode current collector of the negative electrode. Thereafter, the positive electrode and the negative electrode were wound with a separator therebetween to produce a wound electrode group. A microporous film made of polyethylene was used as the separator. The electrode group was housed in a battery case. In the housing, an upper insulating plate and a lower insulating plate each made of resin were disposed above and below the electrode group, respectively. The negative electrode lead was welded to the inner bottom surface of the battery case. The positive electrode lead was welded to a metal sealing body that also serves as a positive electrode terminal. Thereafter, the nonaqueous electrolyte was injected into the battery case, and the opening of the battery case was closed with the sealing body. In the closing, a gasket made of resin was provided between the opening end of the battery case and the sealing body. In the manner described above, cylindrical secondary batteries (nominal capacity 4600 mAh) were obtained.

In Table 1, E1 to E6 indicate batteries of Examples 1 to 6, and R3, R4, R6, and R7 indicate batteries of Comparative Examples 3, 4, 6, and 7.

### Comparative Example 1

The negative electrode mixture layer was formed by forming the first layer and the third layer, using the first slurry and the third slurry. The proportion MB₁ of the graphite particles B in the graphite particles contained in the first slurry and the proportion MB₃ of the graphite particles B in the graphite particles contained in the third slurry were set to the values indicated in Table 1. The thickness T₁ of the first layer and the thickness T₃ of the third layer were set to the values indicated in Table 1. A battery R1 was produced in the same manner as that for producing the battery E1 of Example 1 except the above.

### Comparative Example 2

The negative electrode mixture layer was formed by forming the first layer and the second layer (the 2a layers and the 2b layers) using the first slurry and the second slurry (the first 2a slurry and the first 2b slurry). The proportion MB₁ of the graphite particles B in the graphite particles contained in the first slurry, the proportion MB₂ₐ of the graphite particles B in the graphite particles contained in the 2a slurry, and the proportion MB_{2b} of the graphite particles B in the graphite particles contained in the 2b slurry were set to the values indicated in Table 1. The thickness T₁ of the first layer and the thickness T₂ of the second layer were set to the values indicated Table 1. A battery R2 was produced in the same manner as that for producing the battery E1 of Example 1 except the above.

### Comparative Example 5

The negative electrode mixture layer was formed by forming the second layer (the 2a layers and the 2b layers) and the third layer using the second slurry (the 2a slurry and the 2b slurry) and the third slurry. The thickness T2 of the second layer and the thickness T3 of the third layer were set to the values indicated in Table 1. A battery R5 was produced in the same manner as that for producing the battery E1 of Example 1 except for above.

Each of the batteries produced above was evaluated as follows.

### [Evaluation 1: Cycle Capacity Retention Rate]

In an environment at 25° C., constant current charging was performed at a current of 0.3 C (1380 mA) until the voltage reached 4.2 V, and then constant voltage charging was performed at a voltage of 4.2 V until the current reached 0.02 C. After a 10-minute pause, constant current discharging was performed at a current of 0.5 C until the voltage reached 2.5 V. One cycle of the charging and the discharging was performed 300 times, and a rate (percentage) of the discharge capacity at the 300th cycle to the discharge capacity at the first cycle was determined as a capacity retention rate at the 300th cycle.

### [Evaluation 2: Electrolyte Permeability in Negative Electrode]

To one of the surfaces of the negative electrode (the negative electrode mixture layer), 3 μl of propylene carbonate was dropped as a solvent. The time from the solvent drop to permeation of all of the solvent through the negative electrode mixture layer was measured. Each value for the electrolyte permeability in Table 1 indicates the time (second) measured above. Smaller values indicate better rapid charging characteristics.

Evaluation results are shown in Table 1.

TABLE 1

| | | Second layer | | |
|---|---|---|---|---|
| | Proportion MB₁ | Proportion MB₂ₐ | Proportion MB_{2b} | Proportion MB₃ |
| | of graphite | of graphite | of graphite | of graphite |
| | particles B in | particles B in | particles B in | particles B in |
| | graphite | graphite | graphite | graphite |
| | particles in | particles | particles | particles in |
| | first layer | in 2a layer | in 2b layer | third layer |
| Secondary | (first slurry) | (2a slurry) | (2b slurry) | (third slurry) |
| battery | (% by mas) | (% by mas) | (% by mas) | (% by mas) |
| E1 | 0 | 0 | 100 | 100 |
| E2 | 0 | 20 | 80 | 100 |
| E3 | 0 | 40 | 60 | 100 |
| E4 | 0 | 0 | 100 | 100 |
| E5 | 0 | 0 | 100 | 100 |
| E6 | 0 | 0 | 100 | 100 |
| R1 | 0 | — | — | 70 |
| R2 | 0 | 0 | 80 | — |
| R3 | 0 | 50 | 50 | 100 |
| R4 | 0 | 0 | 100 | 100 |
| R5 | — | 0 | 100 | 100 |
| R6 | 100 | 0 | 100 | 100 |
| R7 | 0 | 0 | 100 | 0 |

| | | | | | Evaluation of |
|---|---|---|---|---|---|
| | | | | Evaluation of | cycle |
| | Thickness | Thickness | Thickness | rapid charging | characteristics |
| | T₁ | T₂ | T₃ | characteristics | Capacity |
| Secondary | of first | of second | of third | Electrolyte | retention rate |
| battery | layer | layer | layer | permeability | (%) |
| E1 | 0.5T | 0.3T | 0.2T | 70 | 86 |
| E2 | 0.5T | 0.3T | 0.2T | 71 | 84 |
| E3 | 0.5T | 0.3T | 0.2T | 22 | 82 |
| E4 | 0.4T | 0.5T | 0.1T | 71 | 81 |
| E5 | 0.55T | 0.2T | 0.25T | 69 | 85 |
| E6 | 0.6T | 0.1T | 0.3T | 70 | 77 |
| R1 | 0.5T | — | 0.5T | 50 | 60 |
| R2 | 0.5T | 0.5T | — | 90 | 77 |
| R3 | 0.5T | 0.3T | 0.2T | 82 | 75 |
| R4 | 0.35T | 0.6T | 0.05T | 85 | 75 |
| R5 | — | 0.5T | 0.5T | 70 | 60 |
| R6 | 0.5T | 0.3T | 0.2T | 70 | 58 |
| R7 | 0.5T | 0.3T | 0.2T | 100 | 60 |

In the batteries E1 to E6, the values for electrolyte permeability were small, and excellent rapid charging characteristics were obtained. In addition, in the batteries E1 to E6, the capacity retention ratio was high, and excellent cycle characteristics were obtained.

In the battery R1, due to the negative electrode mixture layer being made up of only the first layer and the third layer without forming the second layer, the value for electrolyte permeability was large and the capacity retention ratio decreased. In the battery R2, due to the third layer not being formed, the value for electrolyte permeability significantly increased. In the battery R3, due to the second layer being made up of a single layer with a proportion of the graphite particles B in the graphite particles of 50% by mass, the value for electrolyte permeability increased and the capacity retention ratio decreased.

In the battery R4 in which the thickness of the third layer was 0.05T, ineffectiveness of the third layer resulted in an increased value for electrolyte permeability. In the battery R5, due to the first layer not being formed, adhesion between the negative electrode mixture layer and the negative electrode current collector decreased, and the capacity retention ratio decreased. In the battery R6, due to formation of the first layer containing no graphite particles A, adhesion between the negative electrode mixture layer and the negative electrode current collector decreased, and the capacity retention ratio decreased. In the battery R7, due to formation of the third layer containing no graphite particles B, the value for electrolyte permeability increased.

### INDUSTRIAL APPLICABILITY

The secondary battery negative electrode according to the present disclosure is suitably used for secondary batteries that require excellent rapid charging characteristics and cycle characteristics.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### REFERENCE SIGNS LIST

1: electrode group, 2: positive electrode lead, 3: negative electrode lead, 4: battery case, 5: sealing plate, 6: negative electrode terminal, 7: gasket, 8: sealing plug, 20: graphite particles, 21: internal void, 22: external void, 30: negative electrode, 31: negative electrode current collector, 32 and 33: negative electrode mixture layer, 41: first layer, 42: second layer, 42a: 2a layer, 42b: 2b layer, 43: third layer

1. A secondary battery negative electrode comprising:
a negative electrode mixture layer containing a negative electrode active material; and
a negative electrode current collector carrying the negative electrode mixture layer, wherein
the negative electrode active material contains graphite particles,
the graphite particles include graphite particles A having an internal porosity of larger than 5%, and graphite particles B having an internal porosity of 5% or less,
the negative electrode mixture layer includes a first layer, a second layer, and a third layer in order from a side of the negative electrode current collector,
the second layer includes a 2a layer and a 2b layer respectively provided on a first region and a second region of the first layer,
given that MB₁, MB₂ₐ, MB_{2b}, and MB₃ respectively represent proportions (% by mass) of the graphite particles B in a sum of the graphite particles A and the graphite particles B contained in the first layer, the 2a layer, the 2b layer, and the third layer, the MB₁, the MB₂ₐ, the MB_{2b}, and the MB₃ satisfy a relationship of:
0≤MB₁≤MB₂ₐ<50<MB_{2b}≤MB₃≤100, and
given that T represents a thickness of the negative electrode mixture layer, a thickness of the third layer is larger than 0.05T.

2. The secondary battery negative electrode according to claim 1, wherein
the internal porosity of the graphite particles A is 8% or more and 20% or less.

3. The secondary battery negative electrode according to claim 1, wherein
a thickness of the second layer is 0.1T or more and 0.5T or less, and
the thickness of the third layer is 0.1T or more and 0.3T or less.

4. The secondary battery negative electrode according to claim 1, wherein
the MB₂ₐ is 0% by mass or more and 40% by mas or less, and
the MB_{2b} is 60% by mass or more and 100% by mass or less.

5. The secondary battery negative electrode according to claim 1, wherein
the negative electrode active material contains an Si-based material.

6. The secondary battery negative electrode according to claim 1, wherein
a plurality of the 2a layers and a plurality of the 2b layers are arranged in an alternating pattern on the first layer.

7. The secondary batter negative electrode according to claim 6, wherein
the 2a layers and the 2b layers are arranged in a striped pattern, a checkerboard pattern, or a honeycomb pattern on the first layer.

8. The secondary batter negative electrode according to claim 1, wherein
either a plurality of the 2a layers or a plurality of the 2b layers are provided on the first layer, dispersed in island shapes within a sea matrix of other layers.

9. The secondary batter comprising:
a positive electrode;
a negative electrode; and
a nonaqueous electrolyte, wherein
the negative electrode is the secondary battery negative electrode according to claim 1.

10. A method of producing a secondary battery negative electrode, comprising:
a first step of preparing a negative electrode slurry containing graphite particles;
a second step of forming a negative electrode mixture layer by applying the negative electrode slurry to a surface of a negative electrode current collector, followed by dying, and
a third step of compressing a stack of the negative electrode mixture layer and the negative electrode current collector, wherein
in the first step, a first slurry, a second slurry, and a third slurry are prepared to prepare the negative electrode slurry,
in the second step, the negative electrode mixture layer is formed by applying the first slurry, the second slurry, and the third slurry in order to the surface of the negative electrode current collector, the negative electrode mixture layer being composed of a first layer, a second layer, and a third layer disposed in order from a side of the negative electrode current collector,
the second slurry includes a 2a slurry and a 2b slurry,
a step of forming the second layer includes a step of forming 2a layers and 2b layers by applying the 2a slurry and the 2b slurry to a first region and a second region of a first slurry application region of the first slurry, respectively, the 2a layers and the 2b layers forming the second layer,
the graphite particles include graphite particles A having an internal porosity of larger than 5%, and graphite particles B having an internal porosity of 5% or less,
given that MB₁, MB₂ₐ, MB_{2b}, and MB₃ respectively represent proportions (% by mass) of the graphite particles B in a sum of the graphite particles A and the graphite particles B contained in the first slurry, the 2a slurry, the 2b slurry, and the third slurry, the MB₁, the MB₂ₐ, the MB_{2b}, and the MB₃ satisfy a relationship of:
0≤MB₁≤MB₂ₐ<50<MB_{2b}≤MB₃≤100, and
given that T represents a thickness of the negative electrode mixture layer, a thickness of the third layer is larger than 0.05T.

11. The method of producing a secondary battery negative electrode according to claim 10, wherein
the internal porosity of the graphite particles A is 8% or more and 20% or less.

12. The method of producing a secondary battery negative electrode according to claim 10, wherein
a thickness of the second layer is 0.1T or more and 0.5T or less, and
the thickness of the third layer is 0.1T or more and 0.3T or less.

13. The method of producing a secondary battery negative electrode according to claim 10, wherein
the MB₂ₐ is 0% by mass or more and 40% by mass or less, and
the MB_{2b} is 60% by mass or more and 100% by mass or less.
